(19) United States
(12) Patent Application Publication
(10) Pub. No.: US 2019/0084565 A1
(43) Pub. Date: Mar. 21, 2019

(54) VEHICLE SOUND ACTIVATION

(71) Applicant: Ford Global Technologies, LLC, Dearborn, MI (US)

(72) Inventor: Aed M. Dudar, Canton, MI (US)

(73) Assignee: Ford Global Technologies, LLC, Dearborn, MI (US)

(21) Appl. No.: 15/708,332

(22) Filed: Sep. 19, 2017

(51) Int. Cl. B60W 30/165; G05D 1/00; B60W 30/18; G05D 1/02

(52) U.S. Cl. CPC B60W 30/165; G05D 1/0088; B60W 2560/00; G05D 1/0223; B60W 30/18163

(57) ABSTRACT

A system includes a processor for a first vehicle and a memory. The memory stores instructions executable by the processor to, upon determining audio fault of the first vehicle, identify a second vehicle for sound-sharing based on a sound output of the second vehicle, and form a platoon with the second vehicle based on the sound output.

### BACKGROUND

Vehicle engine sounds may gain attention of pedestrians and/or drivers of other vehicles. Therefore, the engine sound may reduce a likelihood of a collision or accident. For example, a pedestrian who intends to cross a street may recognize an oncoming vehicle based on hearing a sound of the vehicle engine. However, some vehicles, such as hybrid or electric vehicles, can be operated without an internal combustion engine, thus lacking a conventional engine sound. Synthetic sound systems may be used to compensate for the lack of an engine sound, e.g., a synthetic sound is produced when a hybrid vehicle is moving by using an electric motor of the vehicle. However, problems are presented by the failure of synthetic sound systems to sometimes fail to operate and/or to operate properly.

### BRIEF DESCRIPTION OF THE DRAWINGS

FIG. 1 is a diagram showing vehicles with respective sound outputs.

FIGS. 2A-2B are a flowchart of an exemplary process of controlling an operation of the vehicle of FIG. 1.

### DETAILED DESCRIPTION

### Introduction

Disclosed herein is a system that includes a processor for a first vehicle, and a memory. The memory stores instructions executable by the processor to, upon determining audio fault of the first vehicle, identify a second vehicle for sound-sharing based on a sound output of the second vehicle, and form a platoon with the second vehicle based on the sound output.

The instructions may include further instructions to identify the second vehicle further based on a lane of travel of the second vehicle and a distance of the second vehicle from the first vehicle.

The second vehicle may be behind the first vehicle and the instructions may include instructions to instruct the second vehicle to overtake the first vehicle and drive in a same lane in front of the first vehicle, based on the sound output.

The second vehicle may be behind the first vehicle, and the instructions may include further instructions to actuate the first vehicle to move behind the second vehicle, based on the sound output.

The instructions may include further instructions to identify the second vehicle based on determining that the sound output compensates for the audio fault.

The instructions may include further instructions to identify the second vehicle based at least on one of a distance of the second vehicle from the first vehicle and a speed of the second vehicle.

The instructions may include further instructions to identify the second vehicle only when a first vehicle speed is less than a speed threshold.

Further disclosed herein is a method comprising, upon determining audio fault of the first vehicle, identifying a second vehicle for sound-sharing based on a sound output of the second vehicle, and forming a platoon with the second vehicle based on the sound output.

The method may further include identifying the second vehicle further based on a lane of travel of the second vehicle and a distance of the second vehicle from the first vehicle.

The method may further include, based on the sound output, instructing the second vehicle behind the first vehicle to overtake the first vehicle, and driving in a same lane in front of the first vehicle.

The method may further include actuating the first vehicle in front of the second vehicle to move behind the second vehicle, based on the sound output.

The method may further include identifying the second vehicle based on determining that the sound output compensates for the audio fault.

The method may further include identifying the second vehicle based at least on one of a distance of the second vehicle from the first vehicle and a speed of the second vehicle.

The method may further include identifying the second vehicle only when a first vehicle speed is less than a speed threshold.

Further disclosed is a computing device programmed to execute the any of the above method steps. Further disclosed is a vehicle comprising the computing device.

Yet further disclosed is a computer program product, comprising a computer readable medium storing instructions executable by a computer processor, to execute any of the above method steps.

### System Elements

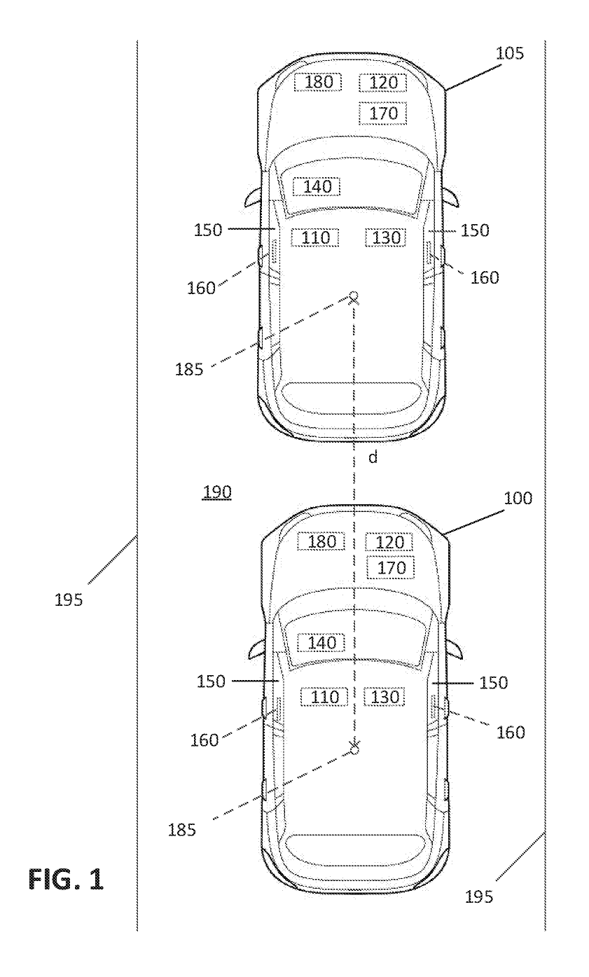

FIG. 1 illustrates first and second vehicles 100, 105. The vehicles 100, 105 may be powered in a variety of known ways, e.g., with an electric motor and/or internal combustion engine. Each of the vehicles 100, 105 may be a land vehicle such as a car, truck, etc. or an airborne vehicle such as a drone. In one example, the first vehicle 100 and the second vehicle 105 may be a drone and a car respectively. Each of the vehicles 100, 105 may include a computer 110, actuator(s) 120, sensor(s) 130, a human machine interface (HMI 140), window(s) 150, window opener(s) 160, an internal combustion (IC) engine 170, a sound output 180 such as a speaker, and other components described herein below. Each of the vehicles 100, 105 has a geometrical center point 185, e.g., points at which respective longitudinal and lateral center lines of the vehicles 100, 105 intersect. As seen in FIG. 1, a first vehicle 100 and a second vehicle 105 may have common elements, each of which are discussed in more detail below.

The computer 110 includes a processor and a memory such as are known. The memory includes one or more forms of computer-readable media, and stores instructions executable by the computer 110 for performing various operations, including as disclosed herein.

The computer 110 may operate the respective vehicle 100, 105 in an autonomous or semi-autonomous mode. For purposes of this disclosure, an autonomous mode is defined as one in which each of vehicle 100 propulsion, braking, and steering are controlled by the computer 110; in a semi-autonomous mode, the computer 110 controls one or two of vehicles 100 propulsion, braking, and steering.

The computer 110 may include programming to operate one or more of land vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally or alternatively, the computer 110 may include programming to operate one or more of airborne vehicle operations including take off, landing, flying, etc. Additionally, the computer 110 may be programmed to determine whether and when a human operator is to control such operations.

The computer 110 may include or be communicatively coupled to, e.g., via a vehicle communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle network, the computer 110 may transmit messages to various devices in the vehicle and/or receive messages from the various devices, e.g., a sensor 130, an actuator 120, a sound output 180, etc. Alternatively or additionally, in cases where the computer 110 actually comprises multiple devices, the vehicle communication network may be used for communications between devices represented as the computer 110 in this disclosure. Further, as mentioned below, various controllers and/or sensors may provide data to the computer 110 via the vehicle communication network.

Actuators 120 of the vehicles 100, 105 are implemented via circuits, chips, and/or other electronic and or mechanical components that can actuate various vehicle subsystems in accordance with appropriate control signals as is known. The actuators 120 may be used to control braking, acceleration, and steering of the vehicles 100, 105.

The vehicles 100, 105 (specifically a vehicle that lacks an engine such as an electric vehicle) may include a sound output 180. The computer 110 may actuate the sound output 180 to generate a sound, e.g., similar to engine 170 sound at an engine idle speed. For example, the computer 110 may actuate the sound output 180 by sending a control instruction including data indicating an amplitude and/or frequency content, i.e., a shape of, sound waves. A sound wave may be decomposed to a sum of multiple sinusoidal waves, such as is known. Each of the sinusoidal waves, herein referred to as a frequency component, includes a frequency. Additionally, a frequency component of a sound wave includes an amplitude of the sound wave. In other words, a sound wave may be a sum of multiple frequency components, each defined by a respective frequency and an amplitude. A sound output 180 includes one or more speakers mounted to the vehicle 100, 105, e.g., under a hood, on a bumper, etc. The sound output 180 may further include electronic components, e.g., amplifiers, chips, etc., for controlling sound output. The sound output 180 may receive analog and/or digital actuating signals from the computer 110.

The computer 110 may actuate a vehicle 100, 105 window opener 160 to open or close a vehicle 100, 105 window 150. A window opener 160 is an actuator, e.g., including an electric motor mechanically coupled to a vehicle 100, 105 window 150, e.g., with rollers that are connected to the motor and that roll the window up and down by friction when the motor is actuated. For example, the computer 110 may actuate the window opener 160 electric motor to open or close the window 150.

In addition, the computer 110 may be configured for communicating through a vehicle-to-vehicle (V-to-V) wireless communication interface with other vehicles 100, 105, e.g., via a vehicle-to-vehicle communication network. The V-to-V communication network represents one or more mechanisms by which the computers 110 of vehicles 100, 105 may communicate with other vehicles 100, 105, and may be one or more of wireless communication mechanisms, including any desired combination of wireless (e.g., cellular, wireless, satellite, microwave and radio frequency) communication mechanisms and any desired network topology (or topologies when multiple communication mechanisms are utilized). Exemplary V-to-V communication networks include cellular, Bluetooth, IEEE 802.11, dedicated short range communications (DSRC), and/or wide area networks (WAN), including the Internet, providing data communication services. For example, the computer 110 of a first vehicle 100 can be programmed to send a control instruction, via a V-to-V wireless communication interface, to a second vehicle 105 to actuate a second vehicle 105 sound output 180.

The computer 110 may receive audio data from audio sensor 130, e.g., a microphone, included in the vehicle 100, 105, e.g., an audio sensor 130 included in a vehicle 100, 105. The microphone may be mounted on and/or near a vehicle 100, 105 exterior. Additionally or alternatively, the microphone may be included in the vehicle 100, 105 HMI 140. The received audio data may indicate an amplitude and/or shape, i.e. frequency content, of received acoustic sound waves.

A vehicle 100, 105 may have an audio fault, which means that sound output 180 of the vehicle 100, 105 is not actuated, or is not properly actuated, upon an instruction form the computer 110. Not properly actuated sound output 180 can mean that the sound output 180 was at an amplitude and/or frequency other than as specified in programming in and/or an instruction from the computer 110. For example, a wiring between the computer 110 and the sound output 180 may be disconnected or loose. As another example a speaker of the sound output 180 may have a deficiency, e.g., a broken cover or other part, a blocked cover, etc.

The computer 110 may be programmed to determine whether the sound output 180 is faulty, i.e., whether a vehicle 100, 105 has an audio fault. For example, the computer 110 may be programmed to determine whether the vehicle 100, 105 has an audio fault by receiving audio data from the audio sensor 130 following an instruction to actuate the sound output 180 and determining whether the received audio data includes an expected amplitude and/or frequency. For example, the computer 110 may be programmed to determine an audio fault upon determining that an amplitude deviation of the expected frequency in the received audio data exceeds a predetermined threshold, e.g., a 10% deviation in amplitude. Upon determining that, e.g., the first vehicle 100 sound output 180 is faulty (i.e., the first vehicle 100 has an audio fault), it can be advantageous if the first vehicle 100 can rely on a sound (e.g., of an engine 170 and/or a sound output 180) generated by another vehicle such as the second vehicle 105.

The first vehicle 100 computer 110 can be programmed to, upon determining audio fault of the first vehicle 100, identify a second vehicle 105 for sound-sharing based on a sound output 180 of the second vehicle 105, and form a platoon with the second vehicle 105 based on the second vehicle 105 sound output 180. “Forming a platoon” may include actuating one or more of the first vehicle 100 actuators 120 such as acceleration, steering, and/or braking actuators 120 based on the identified second vehicle 105, e.g., a distance and/or a speed relative to the second vehicle 105, received instructions from the second vehicle 105, etc.

In the context of this disclosure, “sound-sharing” means allowing an actuation of, e.g., the second vehicle 105, based on an instruction received from a computer 110 external to the second vehicle 105, e.g., the first vehicle 100 computer 110. Thus, the second vehicle 105 sound output 180 is “shared” with the first vehicle 100 and/or provided for the second vehicle 105.

As discussed above, the first vehicle 100 may identify a second vehicle 105 for sound-sharing based on a sound output 180 of the second vehicle 105. For example, the first vehicle 100 computer 110 may be programmed to identify the second vehicle 105 based on determining whether the second vehicle 105 includes a sound output 180, e.g., by sending a message via a wireless communication network to the second vehicle 105.

As another example, the computer 110 may be programmed to identify the second vehicle 105 based on data received from the vehicle 100 sensors 130 such as the audio sensor 130 and/or object detection sensor 130. The vehicle 100 computer 110 may be programmed to identify the second vehicle 105 based on the received object data including the second vehicle 105 and/or audio data including an engine sound of the second vehicle 105.

Additionally or alternatively, the first vehicle 100 computer 110 may be programmed to identify the second vehicle 105 based on determining that the sound output 180 of the second vehicle 105 can compensate for a detected audio fault in the first vehicle 100. For example, the first vehicle 100 computer 110 may be programmed to identify the second vehicle 105 based on receiving a confirmation message, e.g., via the wireless communication network, indicating that the second vehicle 105 accepts to share the second vehicle 105 sound output 180 with the first vehicle 100. Additionally, the first vehicle 100 computer 110 may be programmed to identify a second vehicle 105 that includes an internal combustion engine 170 (i.e., based on sound outputted by the engine 170).

Additionally or alternatively, upon accepting to share sound, the second vehicle 105 computer 110 may be programmed to transmit its route information to the first vehicle 100. The first vehicle 100 computer 110 may be programmed to determine, e.g., how long sound-sharing with the second vehicle 105 may be possible. In one example, the second vehicle 105 may determine that the sound-sharing will end, e.g., because of different routes of the first and second vehicles 100, 105, upon the second vehicle 105 arriving at a location. Thus, the first vehicle 100 computer 110 may be programmed to identify another vehicle upon determining that sound-sharing with the previously identified second vehicle 105 is longer possible.

In another example, the first vehicle 100 computer 110 may be programmed to identify a platoon of second vehicles 105 which can share sound with the first vehicle 100. If some of the identified second vehicles 105 in the platoon, e.g., two out of three second vehicles 105, leave the platoon, the first vehicle 100 may still share sound with the rest of the platoon. Thus, the first vehicle 100 computer 110 may be programmed to identify a platoon of second vehicles 105, to join the identified platoon, and to share sound with the platoon as long as at least one of the second vehicles 105 is present in the platoon.

Typically (but not necessarily), each of the two or more vehicles 100, 105 in a platoon drives in a same lane 190 and one of the vehicles 100, 105 is a lead vehicle, i.e., a vehicle that dictates operations of other vehicles in the platoon, e.g., with respect to speed, steering, etc., e.g., by the other vehicles following the lead vehicle and/or operating according to V-to-V instructions from the lead vehicle. In one example, the lead vehicle (e.g., the second vehicle 105) may be driven in a non-autonomous, semi-autonomous mode, and/or autonomous mode, while other vehicles in the platoon such as the first vehicle 100 follow the lead vehicle in an autonomous mode. Vehicles such as the first vehicle 100 following the lead vehicle are herein referred to as the following vehicles. A platoon may include multiple following vehicles.

The computer 110 of the following first vehicle 100 may be programmed to control a distance d to a vehicle immediately in front of the first vehicle 100, e.g., the lead second vehicle 105 or another middle vehicle in front of the following first vehicle 100. For example, the computer 110 of the first vehicle 100 may be programmed to keep the distance d within a predetermined distance range, e.g., 10 to 20 meters. The distance d in this disclosure is defined relative to center points 185 of the vehicles 100, 105, alternatively, the distances can be relative to any other point in vehicles 100, 105 such as a bumper, etc.

In one example, the distance range can be determined based on a speed of the first and/or second vehicles 100, 105, e.g. a lookup table or the like may specify that the distance d can diminish as speed diminishes, and/or can specify maximum and/or minimum distances d. Additionally or alternatively, the distance range may be based on sound characteristics, e.g., power, frequency, etc. of the second vehicle 105 sound output 180. Thus, a maximum of the predetermined distance range for the distance d between the vehicles 100, 105 can be determined based on the sound characteristics, e.g., a maximum power, of the second vehicle 105 sound output 180. “Power” is typically measured in decibels (dB). For example, the maximum of the predetermined distance may be specified such that the power of the sound received at the first vehicle 100 is at least 50dB. The maximum of the predetermined range may be larger for a sound output 180 with a larger power. The first vehicle 100 computer 110 may be programmed to determine the predetermined distance range to the second vehicle 105 based at least in part on of the second vehicle 105 sound output 180. Additionally or alternatively, the first vehicle 100 computer 110 may be programmed to adjust the predetermined distance range to the second vehicle 105 based on a change in a speed of the second vehicle 105 and/or other middle vehicle immediately in front of the first vehicle 100. For example, the computer 110 may be programmed to increase a maximum of the predetermined range upon an increase of the second vehicle 105 speed.

The first vehicle 100 computer 110 may be programmed to identify the second vehicle 105 further based on a lane 190 of travel of the second vehicle 105 and the distance d of the second vehicle 105 from the first vehicle 100. In one example, the first vehicle 100 computer 110 may be programmed to identify the second vehicle 100 for platooning based on determining whether the second vehicle 105 drives in a same lane 190 as the first vehicle 100 and/or whether the second vehicle 105 is within a predetermined distance, e.g., 100 meters, of the first vehicle 100. Additionally or alternatively, the first vehicle 100 computer 110 may be programmed to identify the second vehicle 105 based on the distance d of the second vehicle 105 from the first vehicle 100 and/or a speed of the second vehicle 105. Yet further additionally or alternatively, the first vehicle 100 computer 110 may be programmed to identify the second vehicle 105 based on a speed of the second vehicle 105 relative to the first vehicle 100, e.g., upon determining that the second vehicle 105 speed is within −10 (i.e., slower) to 10 (i.e., faster) kilometer per hour (kph) relative to the first vehicle 100.

Actuating sound output 180 may be omitted when the vehicle 100 speed exceeds a speed threshold, e.g., 70 kph or some other speed at which sound output 180 for pedestrians, cyclists, other slow-moving vehicles, etc., is deemed not to be warranted. For example, the computer 110 may be programmed to identify the second vehicle only when the first vehicle 100 speed is less than a speed threshold, e.g., 70 kph.

The first vehicle 100 computer 110 may identify a second vehicle 105 that drives behind the first vehicle 100. That may be disadvantageous when the first vehicle 100 computer 110 actuates the second vehicle 105 behind the first vehicle 100 to generate sound, because a sound of the second vehicle 105 behind the first vehicle 100 may lack amplitude and/or frequency to attract attention of other traffic participants, e.g., a pedestrian, in front of the first vehicle 100. In one example, therefore, the first vehicle 100 computer 110 may be programmed to instruct the identified second vehicle 105 to overtake the first vehicle 100 and drive in a same lane 190 in front of the first vehicle 100.

Upon receiving the instruction to overtake, the second vehicle 105 computer 110 may be programmed to actuate the second vehicle 105 actuator(s) 120 to control vehicle 105 operations concerning acceleration, steering, and/or braking actuators to overtake the first vehicle 100 and move to the same lane 190 of the first vehicle 100 in front of the first vehicle 100. The second vehicle 105 computer 110 may be programmed to overtake the first vehicle 100 based on data received from the second vehicle 105 sensors 130 such as radar, camera sensor 130, etc. “Overtaking” as in this context and consistent with the term as plainly and ordinarily generally understood means changing a lane 190 to, e.g., a second lane 190 to a right or left of the current lane 190, accelerating to overtake the first vehicle 100, and then changing the lane 190 from the second lane 190 back to the lane 190 of the first vehicle 100. “Overtaking” may include two or more lanes 190 changing, acceleration and/or braking operations. As another example, the first vehicle 100 computer 110 may be programmed to actuate the first vehicle 100 actuator(s) 120 to change to a second lane 190, decelerate the first vehicle 100, and then position itself behind the second vehicle 105 by changing back to the same lane 190 of the second vehicle 105.

Upon determining an audio fault of the first vehicle 100, the first vehicle 100 computer 110 may be programmed to actuate a first vehicle 100 media device such as a vehicle 100 radio to generate an engine sound, e.g., by playing a prerecorded sound. To facilitate better broadcasting of the sound of, e.g., the radio, the first vehicle 100 computer 110 may be further programmed to actuate a vehicle 100 window opener 160 to open a vehicle 100 window 150.

### Processes

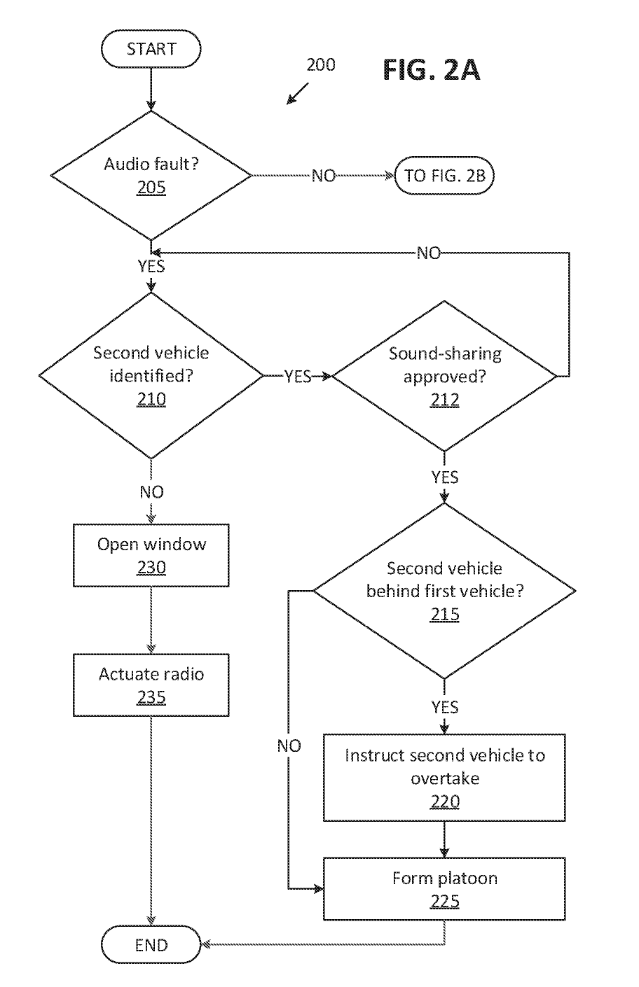

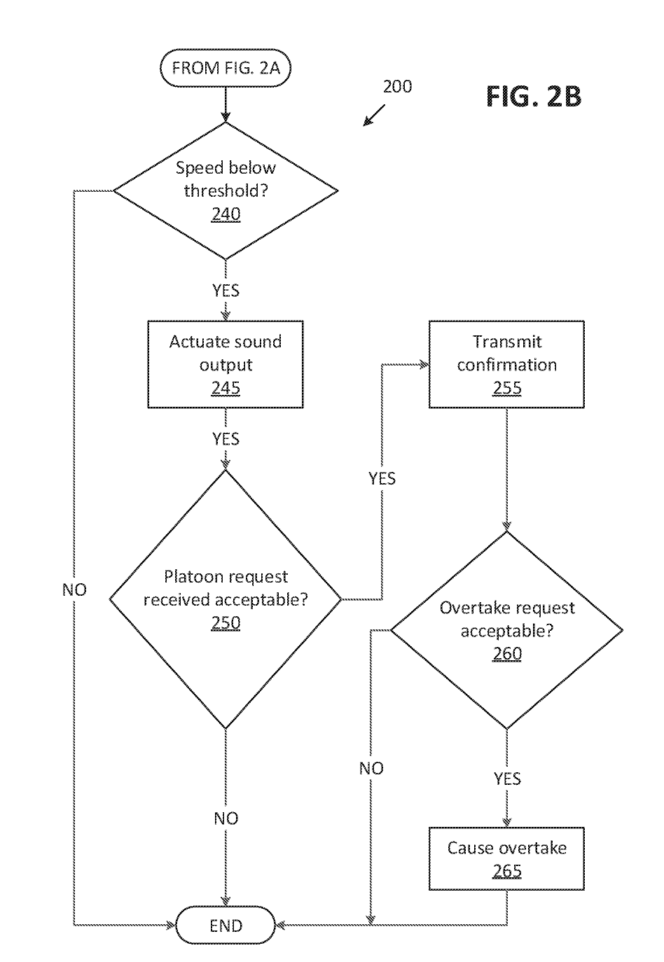

FIGS. 2A-2B are a flowchart of an exemplary process 200 of controlling a vehicle operation. For example, each of the vehicles 100, 105 computer 110 may be programmed to execute blocks of the process 200. For convenience, the process 200 is described with respect to the vehicle 100, but the process can apply to more than one vehicle 100.

The process 200 begins in a decision block 205, the computer 110 of the vehicles 100, 105 determine whether the vehicle 100, 105 has an audio fault as described above. If the computer 110 determines that the vehicle 100, 105 has an audio fault, then the process 200 proceed to a decision block 210; otherwise the process 200 proceeds to a decision block 240 (see FIG. 2B). For convenience and not to indicate any order or precedence, here below, the vehicle 100 may detect the audio fault (i.e., proceeding to the decision block 210), whereas the second vehicle 105 has no audio fault (i.e., proceeding to the decision block 240).

In the decision block 210, the first vehicle 100 computer 110 determines whether a second vehicle 105 is identified for sound-sharing. For example, as explained above, the first vehicle 100 computer 110 may be programmed to identify the second vehicle 105 that drives based on a lane 190 of travel of the second vehicle 105 and the distance d of the second vehicle 105 from the first vehicle 100. Additionally or alternatively, the first vehicle 100 computer 110 may be programmed to identify the second vehicle 105 based on a speed of the second vehicle 105. In one example, the first vehicle 100 computer 110 may be programmed to identify the second vehicle 105 for sound-sharing based on data received from the first vehicle 100 sensors 130, e.g., the audio sensor 130, a camera sensor 130. If the first vehicle 100 computer 110 identifies a second vehicle 105, then the process 200 proceeds to a decision block 212; otherwise the process 200 proceeds to a block 230.

In the decision block 212, the computer 110 determines whether the identified second vehicle 105 accepts a sound-sharing request. For example, the computer 110 may be programmed to transmit a platoon request message to the second vehicle 105 and to determine that the second vehicle 105 has accepted a sound-sharing request upon receiving a confirmation message, e.g., via the wireless communication network, from the second vehicle 105 indicating that the second vehicle 105 accepts sound-sharing with the first vehicle 100. If the computer 110 determines that the identified second vehicle 105 accepts a sound sharing request, then the process 200 proceeds to a decision block 215; otherwise the process 200 returns to the decision block 210 (to, e.g., determine another second vehicle 105 for sound-sharing).

In the decision block 215, the first vehicle 100 computer 110 determines whether the identified second vehicle 105 is behind the first vehicle 100, e.g., in a same lane 190 as the first vehicle 100. In one example, the first vehicle 100 computer 110 may be programmed to determine whether the second vehicle 105 is behind the first vehicle 100 based on location coordinates of the first and second vehicle 100, 105, the first vehicle 100 sensor 130 data, etc. If the first vehicle 100 computer 110 determines that the second vehicle 105 is behind the first vehicle 100, then the process 200 proceeds to a block 220; otherwise the process 200 proceeds to a block 225.

In the block 220, the first vehicle 100 computer 110 instructs the second vehicle 105 to overtake the first vehicle 100. For example, the first vehicle 100 may be programmed to send an instruction to the second vehicle 105 including the first vehicle 100 location coordinates, the speed of the first vehicle 100, etc. Additionally or alternatively, the first vehicle 100 computer 110 may be programmed to actuate the first vehicle 100 actuators 120 to change a lane 190, decelerate, and then change lane 190 to position the first vehicle 100 behind the second vehicle 105 in the same lane 190.

In the block 225, the first vehicle 100 computer 110 causes the first vehicle 100 to form a platoon. The first vehicle 100 computer 110 may be programmed to control a distance d to a vehicle immediately in front of the first vehicle 100, e.g., the lead second vehicle 105 or another middle vehicle in front of the following first vehicle 100. For example, the computer 110 of the first vehicle 100 may be programmed to keep the distance d within a predetermined distance range, e.g., 10 to 20 meters. The first vehicle 100 computer 110 may be programmed to adjust the predetermined distance based on a change in a speed of the second vehicle 105 and/or other middle vehicle immediately in front of the first vehicle 100.

In the block 230, the first vehicle 100 computer 110 actuates the first vehicle 100 window 150 to open. The computer 110 may be programmed to open one or more of the first vehicle 100 windows 150 by actuating the vehicle 100 window opener(s) 160.

Next, in a block 235, the first vehicle 100 computer 110 actuates a vehicle 100 radio and/or any other media player of the vehicle 100 to generate a sound, e.g., a pre-recorded engine sound.

Continuing the description of the process 200 with reference to FIG. 2B, the computer 110 determines whether the vehicle 100, 105 speed is below a speed threshold, e.g., 70 kph. If the computer 110 determines that the speed, e.g., of the second vehicle 105, is below the speed threshold, then the process 200 proceeds to a block 245; otherwise the process 200 ends, or alternatively, returns to the decision block 205 (see FIG. 2A).

In the block 245, the second vehicle 105 computer 110 actuates the second vehicle 105 sound output 180 to generate sound.

Next, in a decision block 250, the second vehicle 105 computer 110 determines whether a received platoon request for sound-sharing (e.g., via the wireless network) is acceptable. For example, the second vehicle 105 computer 110 may be programmed to determine that the received request is acceptable upon determining that a distance d between the vehicles 100, 105 is less than a predetermined threshold and/or a relative speed of the vehicles 100, 105 is less than a predetermined relative speed threshold, e.g., 10 kph. If the computer 110 determines that the received request for platooning is acceptable, the process 200 proceeds to a block 255; otherwise (i.e., no request received or received request determined to be unacceptable) the process 200 ends, or alternatively, returns to the decision block 205.

In the block 255, the computer 110 transmits a confirmation message to the first vehicle 100. In one example, the second vehicle 105 computer 110 may be programmed to adjust a sound characteristic such as the power of the generated sound based on the first vehicle 100 distance d to the second vehicle 105. Additionally or alternatively, the second vehicle 105 computer 110 may be programmed to increase the power of the sound output 180 upon determining that the distance d of the first vehicle 100 to the second vehicle 105 exceeds a predetermined threshold, e.g., 30 meters. Additionally or alternatively, the second vehicle 105 computer 110 may be programmed to transmit its route information to the first vehicle.

Next, in a decision block 260, the computer 110 determines whether an overtake request has been received. For example, the second vehicle 105 computer 110 may receive an overtake request from the first vehicle 100 driving immediately in front of the second vehicle 105, e.g., in the same lane 190. The received request may include location coordinates and/or speed of the vehicle 100 requesting the overtake. If the second vehicle 105 computer 110 receives the overtake request, then the process 200 proceeds to a block 265; otherwise the process 200 ends, or alternatively returns to the decision block 205.

In the block 265, the second vehicle 105 computer 110 actuates the second vehicle 105 actuators 120 to overtake the first vehicle 100 or multiple vehicle including the first vehicle 100. The computer 110 may be programmed to actuate acceleration, steering, and/or braking actuators 120 to change lane 190, accelerate, and change back to the same lane 190 of the first vehicle 100. Following the block 265, the process 200 ends, or alternatively returns to the decision block 205.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising a processor for a first vehicle; and a memory, the memory storing instructions executable by the processor to:
upon determining audio fault of the first vehicle, identify a second vehicle for sound-sharing based on a sound output of the second vehicle; and
form a platoon with the second vehicle based on the sound output.

2. The system of claim 1, wherein the instructions include further instructions to identify the second vehicle further based on a lane of travel of the second vehicle and a distance of the second vehicle from the first vehicle.

3. The system of claim 1, wherein the second vehicle is behind the first vehicle and the processor is further programmed, based on the sound output, to instruct the second vehicle to overtake the first vehicle and drive in a same lane in front of the first vehicle.

4. The system of claim 1, wherein the second vehicle is behind the first vehicle, and the processor is further programmed, based on the sound output, to actuate the first vehicle to move behind the second vehicle.

5. The system of claim 1, instructions include further instructions to identify the second vehicle based on determining that the sound output compensates for the audio fault.

6. The system of claim 1, instructions include further instructions to identify the second vehicle based at least on one of a distance of the second vehicle from the first vehicle and a speed of the second vehicle.

7. The system of claim 1, instructions include further instructions to identify the second vehicle only when a first vehicle speed is less than a speed threshold.

8. A method, comprising:
upon determining audio fault of the first vehicle, identifying a second vehicle for sound-sharing based on a sound output of the second vehicle; and
forming a platoon with the second vehicle based on the sound output.

9. The method of claim 8, further comprising identifying the second vehicle further based on a lane of travel of the second vehicle and a distance of the second vehicle from the first vehicle.

10. The method of claim 8, further comprising, based on the sound output, instructing the second vehicle behind the first vehicle to overtake the first vehicle, and driving in a same lane in front of the first vehicle.

11. The method of claim 8, further comprising, based on the sound output, actuating the first vehicle in front of the second vehicle to move behind the second vehicle.

12. The method of claim 8, further comprising identifying the second vehicle based on determining that the sound output compensates for the audio fault.

13. The method of claim 8, further comprising identifying the second vehicle based at least on one of a distance of the second vehicle from the first vehicle and a speed of the second vehicle.

14. The method of claim 8, further comprising identifying the second vehicle only when a first vehicle speed is less than a speed threshold.
